(19) United States
(12) Patent Application Publication
(10) Pub. No.: US 2014/0311587 A1
(43) Pub. Date: Oct. 23, 2014

(54) Water Supply Conduit Heating Device

(71) Applicant: PLAN 9, INC., White Salmon, WA (US)

(72) Inventor: Mark Eugene Ellis, White Salmon, WA (US)

(73) Assignee: PLAN 9, INC., White Salmon, WA (US)

(21) Appl. No.: 14/248,792

(22) Filed: Apr. 9, 2014

Related U.S. Application Data
(60) Provisional application No. 61/813,678, filed on Apr. 19, 2013.

(51) Int. Cl. F24H 9/12; F16L 11/12

(52) U.S. Cl. CPC F24H 9/12; F16L 11/12
USPC 137/111

(57) ABSTRACT

Embodiments of the Water Supply Conduit Heating are comprised of a control apparatus and a delivery apparatus. The control apparatus is comprised of two electrically actuated solenoid valves, a pump, a hot water connection, a cold water connection, an electronic control, a temperature sensor, and a double-pipe source connection. The two electrically actuated solenoid valves are controlled by the electronic control. As the temperature of the fluid inbound from the source varies, the electronic control adjusts the mix of hot water and cold water from the hot water connection and the cold water connection to provide an appropriate temperature fluid to the outbound fluid to the source connection. The electronic control is used to measure the temperature of the fluid in the conduit and to direct fluid into the conduit as required to control fluid temperature.

### CROSS-REFERENCE TO RELATED APPLICATIONS

This application is a non-provisional patent application of pending U.S. provisional patent application with Ser. No. 61/813,678 titled “Water Supply Conduit Heating Device” filed on May 23, 2013. This application claims priority of U.S. provisional patent application with Ser. No. 61/813,678, and the entire contents of U.S. provisional patent application with Ser. No. 61/813,678 is herein incorporated by reference.

### STATEMENT REGARDING FEDERALLY SPONSORED RESEARCH OR DEVELOPMENT

Not applicable

### FIELD OF THE EMBODIMENTS

The field of the embodiments of the Water Supply Conduit Heating Device is heating devices use to prevent freezing of outside water supply conduits.

### BACKGROUND OF THE EMBODIMENTS

The background of the embodiments of the Water Supply Conduit Heating Device relates to heating devices to prevent freezing of water supply conduits. The application of embodiments includes recreation vehicle water supply use and agricultural water supply use.

In applications where a water supply is available in sub-freezing temperatures, such as for a recreational vehicle (“RV”) or agricultural use, an electrically heated garden hose is normally used. The heating element can be incorporated into the hose (“stand alone”) or it can be installed as “heat tape” or heating tracing. The stand alone hoses are relatively thick, inflexible and costly. In addition, stand alone hoses are not designed to heat other plumbing components, such as hydrants, thus requiring supplemental heating for those items. The heat tape method requires installation by continuous attachment to the freeze prone items (hose, hydrant, etc.) and insulation of heated areas. If the installation is not done well a single cold spot due to non contact with the heat tape will result in ice. This installation must be undone to move the components; a disadvantage in an RV application. Hose heating elements must be provided with 110 VAC power. Given the tough application environment and deterioration of components there is risk of electrical shock. Some types of heat tape may overheat if overlapped resulting in risk of electrical shock and fire. Stock tanks are usually heated by high amperage submersible 110 VAC heaters with similar risks.

The operating environment of this equipment is harsh. A major complaint is that these hose heating systems do not last more than 2-3 years and that the replacement cost is high.

### SUMMARY OF THE EMBODIMENTS

In summary, the embodiments of the Water Supply Conduit Heating Device are comprised of a control apparatus and a delivery apparatus. The control apparatus is comprised of two electrically actuated solenoid valves, a pump, a hot water connection, a cold water connection, an electronic control, a temperature sensor, and a double-pipe source connection.

The two electrically actuated solenoid valves are controlled by the electronic control. As the temperature of the fluid inbound from the source varies, the electronic control adjusts the mix of hot water and cold water from the hot water connection and the cold water connection to provide an appropriate temperature fluid to the outbound fluid to the source connection.

The electronic control is used to measure the temperature of the fluid in the conduit and to direct either heated or cooled or non-heated (cooled) fluid into the conduit as required to control fluid temperature. Fluid flow is directed by use of electrically solenoid controlled valves.

In this respect, it is to be understood that the embodiments in this application are not limited to the details of construction and to the arrangements of the components set forth in the description or illustrated in the drawings. The embodiments are capable of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the embodiments described in this application. Additional benefits and advantages of the present embodiments will become apparent in those skilled in the art to which the embodiments relate from the description of the preferred embodiment and the appended claims, taken in conjunction with the accompanying drawings. It is important, therefore, that the claims be regarded as including such equivalent constructions insofar as they do not depart from the spirit and scope of the embodiments described herein.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the embodiments of the application, which is measured by the claims, nor is it intended to be limiting as to the scope of the embodiments in any way.

### BRIEF DESCRIPTION OF THE DRAWINGS

FIG. 1 is a schematic view of an embodiment of the Water Supply Conduit Heating Device showing the direction of hydraulic flow in the interior heating (or cooling) section of the device.

FIG. 2A is a schematic view of an embodiment of the Water Supply Conduit Heating Device showing hydraulic flow in the external section of the embodiment; FIG. 2B is a schematic view of a cross section of the heating conduit.

FIG. 3 is a schematic view of an embodiment of the Water Supply Conduit Heating Device using a flow restriction as a flow control means.

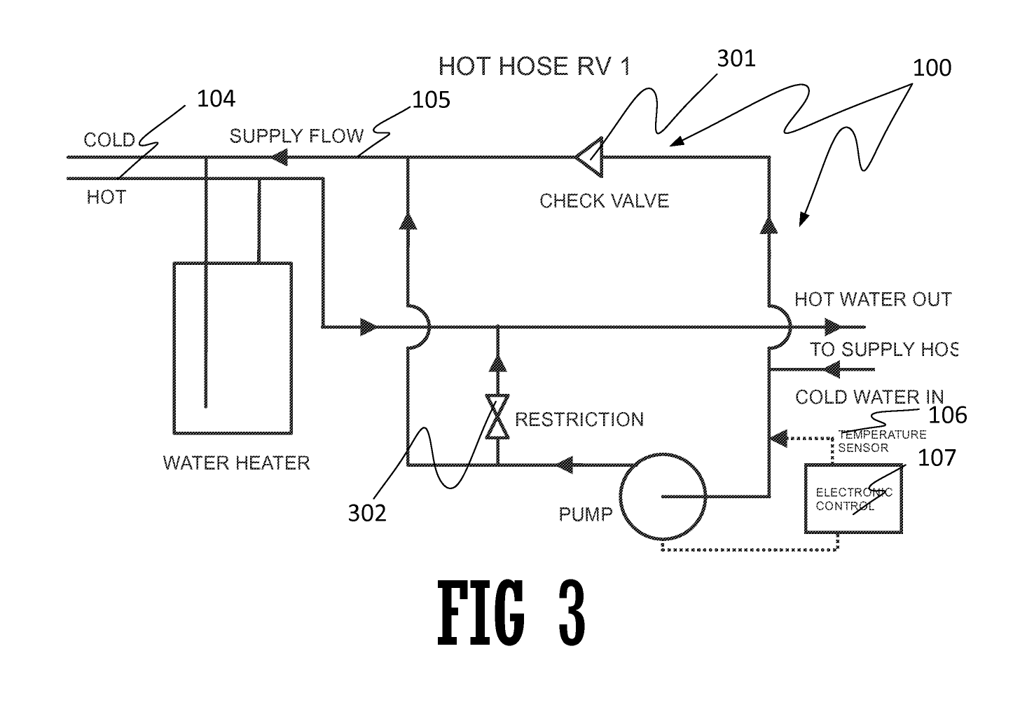

FIG. 4 is a schematic view of an embodiment of the Water Supply Conduit Heating Device using a solenoid valve manifold as a flow control means.

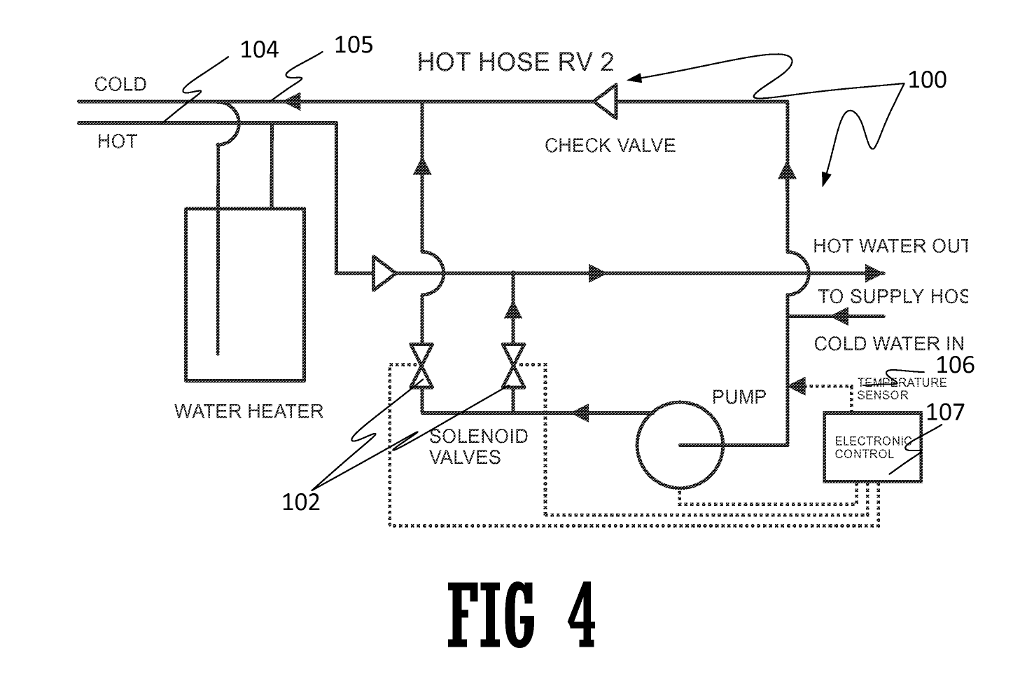

FIG. 5 is a schematic view of an embodiment of the Water Supply Conduit Heating Device employing an integral water heater.

### DETAILED DESCRIPTION OF THE PREFERRED EMBODIMENTS

The Water Supply Conduit Heating Device 100 is freeze proof water supply system that can transfer heat. It comprises three main characteristics. First, it is a fluid containing single conduit that can be heated or cooled evenly from end to end. This allows it to be freeze proof or otherwise temperature controlled. Second, it can transfer fluids from on end of the conduit to the opposite end. Third, it can transfer heat (or cold) to objects as desired.

Embodiments of the Water Supply Conduit Heating Device 100 are comprised of a control apparatus 101 and a delivery apparatus 200. The control apparatus 101 is comprised of two electrically actuated solenoid valves 102, a pump 103, a hot water connection 104, a cold water connection 105, an electronic control 107, a temperature sensor 106, and a double-pipe source connection.

The two electrically actuated solenoid valves 102 are controlled by the electronic control. As the temperature of the fluid inbound from the source varies, the electronic control 107 adjusts the mix of hot water and cold water from the hot water connection 104 and the cold water connection 105 to provide an appropriate temperature fluid to the outbound fluid to the source connection.

The electronic control 107 is used to measure the temperature of the fluid in the conduit and to direct either heated or cooled or non-heated(cooled) fluid into the conduit as required to control fluid temperature. Fluid flow is directed by use of electrically solenoid controlled valves.

An alternate configuration has no solenoid valves 102. Instead a restricted passage 302 is provided to allow a part of the flow from the pump discharge to pass directly to the outbound passage of the conduit. This configuration causes a mixture of heated (cooled) and non-heated (cooled) fluid to be circulated through the conduit.

The pump 103 supplies the motive force to recirculate the fluid into the outbound connection to the fluid source and back through the inbound connection from the source. As the temperature varies as monitored via the temperature sensor 106, the electronic control 107 varies the position of the two solenoid valves 102 thereby adjusting the temperature of the fluid in the outbound connection. The pump 103 injects a heated or cooled fluid into one passage of the conduit. This fluid travels to the opposite end of the conduit and returns to the inlet of the pump 103 via the remaining passage. This circulation of temperature controlled fluid maintains the conduit at a desired temperature. The conduit can also transfer the fluid from one end to the other (water supply).

The hot water connection 104 of the control apparatus 101 allows hot fluid from a heating device to enter the control apparatus 101 and be pumped into the outbound connection to the source thereby controlling the temperature of the conduit connecting the source. The solenoid valves 102 via the electronic control system control the ratio of hot fluid to cold fluid.

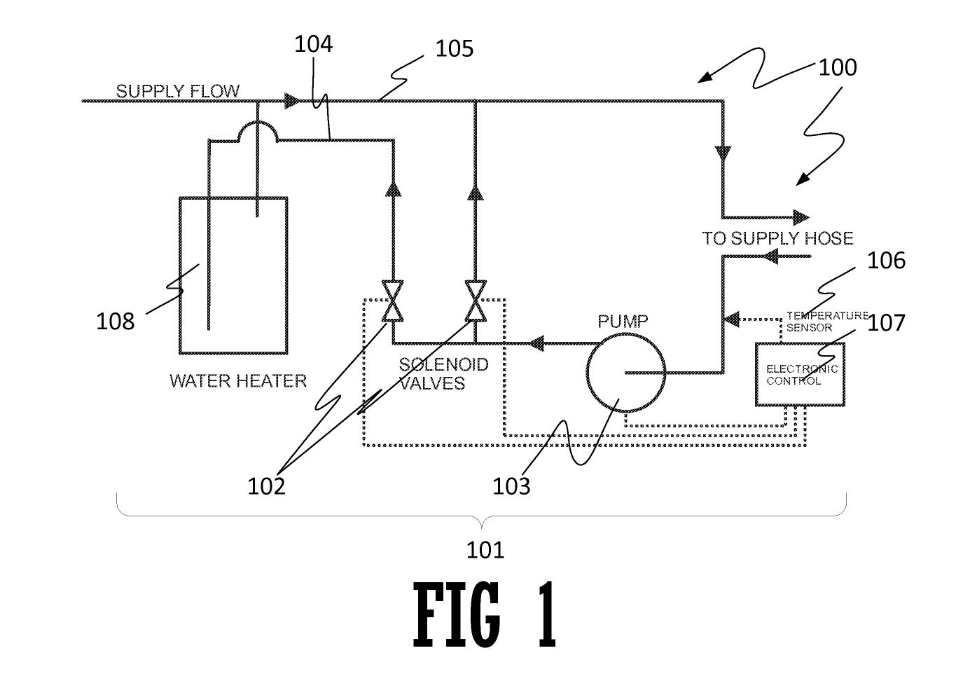

The cold water connection 105 of the control apparatus 101 performs in much the same way as the hot water connection 104. The cold water connection 105 allows cold fluid from a heating device to enter the control apparatus 101 and be pumped into the outbound connection to the source thereby controlling the temperature of the conduit connecting the source. The solenoid valves 102 via the electronic control system control the ratio of hot fluid to cold fluid. The cold water connection 105 also serves as a conduit from the heating device for warm fluid to return to the control apparatus 101 as shown in FIG. 1.

The electronic control 107 of the control apparatus 101 performs the control function of the Water Supply Conduit Heating Device 100. A user-supplied set point is entered into the electronic control 107 and is compared to the temperature signal from the temperature sensor 106. The electronic control 107 then performs a pre-programmed control calculation to determine the position of the two solenoid valves 102. An electronic signal is provide to each solenoid valve 102 to fully open or fully close each solenoid valve 102.

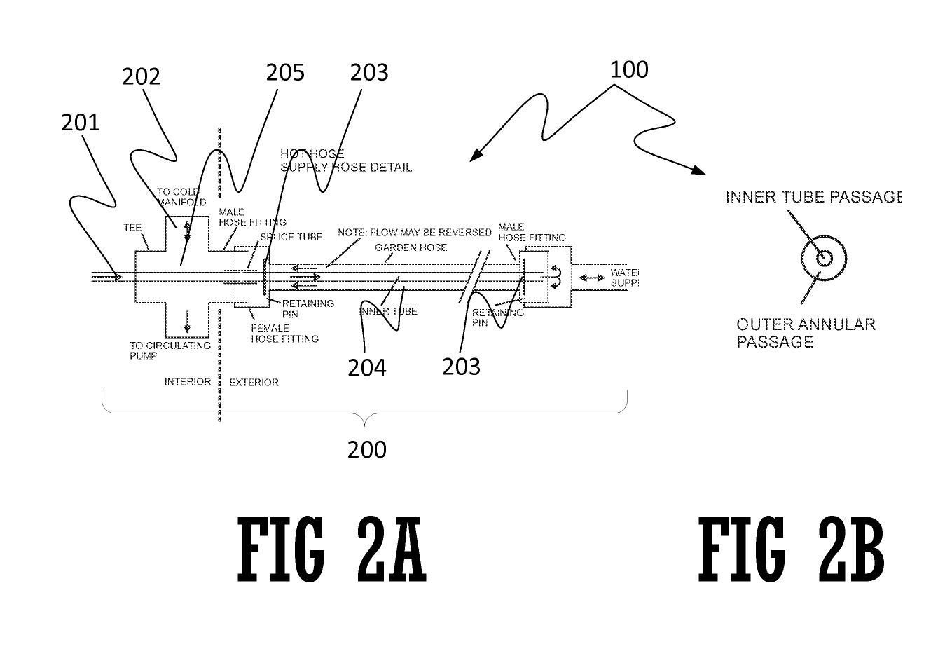

The double-pipe source connection, shown in FIG. 2A, is the connection between the control apparatus 101 and the delivery apparatus 200. The double-pipe source connection is comprised of a return tube 201, a cross-connection 202, a female hose fitting, a splice tube, and two retaining pins 203.

In one embodiment of the Water Supply Conduit Heating Device 100, the return tube 201 provides a fluid connection between the hot water supply, the solenoid valves 102, and the inner tube in the delivery apparatus 200. In another embodiment of the Water Supply Conduit Heating Device 100, the return tube 201 provides a fluid connection between the cold water manifold, the solenoid valves 102, and the inner tube in the delivery apparatus 200.

The cross-connection 202 provides a fluid connection among the cold fluid manifold, the pump 103, and the annular flow connection 204 in the delivery apparatus 200. On average, fluid can travel in one of two directions: in through the annular flow connection 204 and out through the return tube 201, or out through the annular flow connection 204 and in through the return tube 201. Either way, temperature controlled fluid enters and exits the delivery apparatus 200 thereby maintain a temperature control of the delivery apparatus 200.

As cold water is used in the application device, water will flow through the cross-connection out to the cold fluid manifold. In this manner, fluid is delivered from the source to the application device. A check valve 301 is placed in the line between the cross-connection 202 and the cold water line to the application device. This check valve 301 permits flow to the application device and prevents flow from the cold water line of the application device back to the cross-connection 202.

A female hose connection secures the delivery apparatus 200 to the cross-connection 202 by a threaded connection to the male hose fitting on the cross-connection 202. This female hose connection also allows for a fluid connection to the annular flow connection 204 in the delivery apparatus 200.

The splice tube 205 serves as a fluid and mechanical connection between the return tube 201 and the inner tube of the delivery apparatus 200. The splice tube mechanically secures the return tube 201 and the inner tube and prevents fluid from short circuiting between the annular fluid connection and the inner tube fluid connection.

The retaining pins 203 serve as a mechanical connection between the delivery apparatus 200 and the male hose connection of the delivery apparatus 200. The retaining pins 203 are placed through the inner tube and extends serve to secure the inner tube to the male hose connection. The inner tube and two retaining pins 203 are affixed to the delivery apparatus 200. When removing the hose from the cross-connection 202 or hydrant the pins 203 stay remain with the hose and retain the inner tube in the delivery apparatus 200. The connection of the inner tube to the control unit is a slip fit with the splice tube.

The delivery apparatus 200 is comprised of a double pipe conduit with a cross-connection 202 end and a source connection end. The fluid used to control the temperature of the delivery apparatus 200 flows in one side of the double pipe conduit (either the inner tube or the annular conduit) and returns via the other conduit. The fluid can be used to either heat or cool the delivery apparatus 200 and the source connection. The delivery apparatus 200 can be of any length. Energy is exchanged through the walls of the inner tube thereby controlling the temperature of the delivery apparatus 200. Further, energy is transferred to the source through energy exchange via the connection to the hydrant as the delivery apparatus 200 will be at a warmer temperature than the hydrant and will supply energy to the hydrant.

Movement of fluid and heat is accomplished by a ‘tube within a tube’ conduit configuration. A smaller tube is inserted into the full length of the main fluid conduit. This forms two passages; the inner tube passage and the annular passage. These two passages may be used interchangeably for inbound/outbound flow from the pump 103.

The cross-connection 202 end is inserted into the female hose connection and the inner tube is secured with the cross-connection 202 retaining pin. The cross-connection 202 end is then secured to the cross-connection 202 via the female hose connection and the male hose connection on the cross-connection 202. See FIG. 2.

The source connection end, shown in FIG. 2, is comprised of a male hose fitting and a source retaining pin. The inner tube extends the complete longitudinal length of the delivery apparatus 200 and is co-axial with the outer conduit. The source retaining pin secures the inner tube to the male hose fitting.

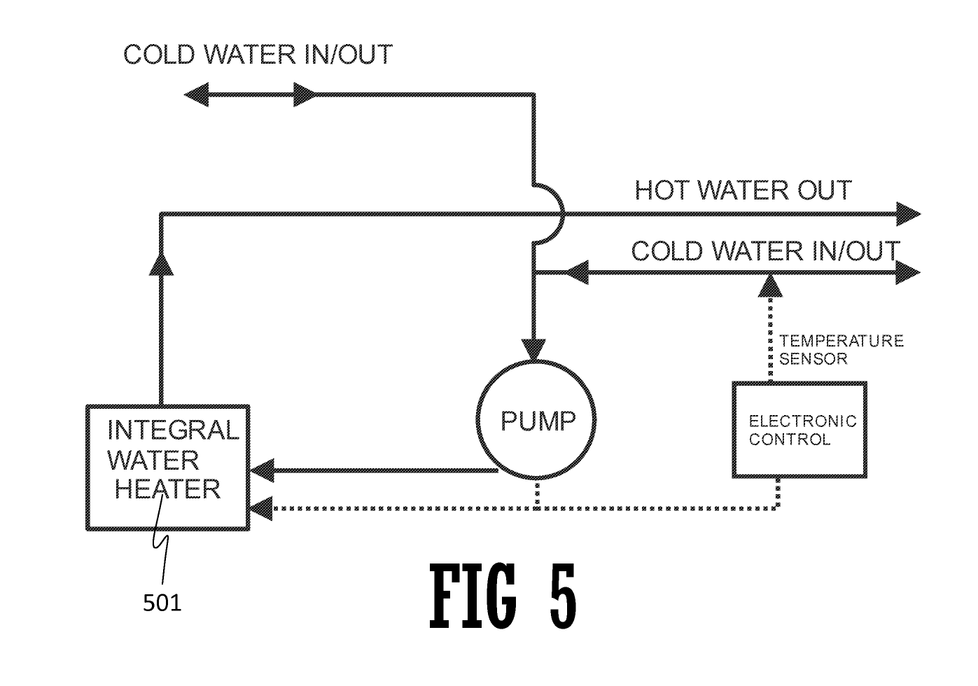

In one embodiment of the Water Supply Heating Device 100, the water heater 108 is external to hydraulic loop. In another embodiment of the Water Supply Conduit Heating Device, the embodiment includes an integral water heater 501 to heat the water. As shown in FIG. 5, by not connecting to the remote water heater the plumbing gets simpler. Unlike the simpler RV version water can flow in both directions. A heater that is external to the hydraulic loop means a heater that is available to the flow loop, but not contained within the flow loop such as a heater in an RV.

The embodiments of the Water Supply Conduit Heating Device can be used in any application requiring temperature control of a fluid connection between a fluid source and the application. One example application is the freeze proof water supply hose for use with RVs. A second example application is the use of a freeze proof water supply system for agricultural use.

In the RV application the control unit is installed in the RV and water from the RV water heater is used to heat the hose. The delivery apparatus 200 supplies water from an external source (water hydrant, etc.) to the RV water system. The delivery apparatus 200 can be used to transfer heat to associated plumbing (hydrants, etc.) by contact to prevent their freezing. Some of the advantages of this application are that the RV can maintain its water connection using water heated by onboard propane. The hose can be replaced easily and at small cost. The light, flexible hose bends easily to conform to hydrants and other water sources. In addition, no high voltage is used by the Water Supply Conduit Heating Device 100.

In the agricultural application the control unit would typically be installed in a heated structure with a source of heated water. The hose would supply a stock watering device (stock tank or valved outlet) to provide drinking water for animals. In the case of a stock tank extra hose would be provided and would lie in the stock tank. This would allow transfer of heat from the hose to the stock tank water to prevent freezing of the tank.

In yet another use for the agricultural system is for water supply and temperature control of small (ornamental) ponds or aquaculture tanks. In either agricultural application example the Water Supply Conduit Heating Device 100 may also be used for general utility purposes such as wash down, plant or pet watering during freezing conditions.

I claim:

1. A water supply conduit heating device comprised of
a. a delivery apparatus,
b. a control unit,
c. wherein the delivery apparatus is comprised of
i. a large outer conduit,
ii. a smaller inside conduit which is inserted into the full length of the larger outer main fluid conduit
iii. wherein the large outer conduit and the smaller inside conduit forms two hydraulically connected passages,
iv. wherein two hydraulically connected passages are the inner tube passage and the annular passage formed by the space between the inside of the large outer conduit and outside of the smaller inside conduit
v. wherein these two hydraulically connected passages may be used interchangeably for inbound/outbound flow from the pump.
d. wherein the control unit is comprised of
i. a pump which injects a heated or cooled fluid into one of hydraulically connected passages, wherein the fluid travels to the opposite end of the conduit and returns to the inlet of the pump via the other hydraulically connected passage,
ii. an electronic control means which is used to measure the temperature of the fluid in the conduit and to direct fluid of a desired temperature into the conduit as required to control fluid temperature, and
iii. a flow control means.

2. The water supply conduit heating device described in claim 1 wherein the flow control means is comprised of one or more electrically actuated solenoid valves.

3. The water supply conduit heating device described in claim 2 wherein the electronic control adjusts the electrically actuated solenoid valves such that as the temperature of a fluid inbound from the source varies the electronic control adjusts the mix of hot water and cold water from a hot water connection and a cold water connection to provide an appropriate temperature fluid to a outbound fluid to the source connection.

4. The water supply conduit heating device described in claim 3 wherein the hot water connection of the control apparatus permits hot fluid from a heating device to enter the control apparatus and be pumped into the outbound connection to the source thereby controlling the temperature of the conduit connecting the source.

5. The water supply conduit heating device described in claim 4 wherein a connection between the control apparatus and the delivery apparatus which is a double-pipe source connection is the connection between the control apparatus 101 and the delivery apparatus.

6. The water supply conduit heating device described in claim 5 wherein the double-pipe source connection is comprised of a return tube, a cross-connection, a female hose fitting, a splice tube, and two retaining pins.

7. The water supply conduit heating device described in claim 6 wherein the return tube provides a fluid connection between the hot water supply, the solenoid valves, and the inner tube in the delivery apparatus.

8. The water supply conduit heating device described in claim 6 wherein the cross-connection provides a fluid connection among the cold fluid manifold, the pump, and the annular flow connection in the delivery apparatus wherein fluid can travel in one of two directions either in through the annular flow connection and out through the return tube, or out through the annular flow connection and in through the return tube.

9. The water supply conduit heating device described in claim 1 wherein the flow control means is comprised of a restricted passage to allow a part of the flow from the pump discharge to pass directly to the outbound passage of the conduit which causes a mixture of heated and non-heated fluid to be circulated through the conduit.
